(19) United States
(12) Patent Application Publication
(10) Pub. No.: US 2015/0126912 A1
(43) Pub. Date: May 7, 2015

(54) NEGATIVE PRESSURE ON NECK TO TREAT OBSTRUCTIVE SLEEP APNEA

(71) Applicant: KONINKLIJKE PHILIPS N.V., EINDHOVEN (NL)

(72) Inventor: Eugene Nelson Scarberry, Trafford, PA (US)

(21) Appl. No.: 14/405,291

(22) PCT Filed: Jun. 4, 2013
(86) PCT No.: PCT/IB2013/054582

§ 371 Date: Dec. 3, 2014

Related U.S. Application Data
(60) Provisional application No. 61/655,542, filed on Jun. 5, 2012.

(51) Int. Cl. A61H 9/00

(52) U.S. Cl. CPC A61H 9/00; A61H 2201/1657
USPC 601/6

(57) ABSTRACT

Systems and methods to treat obstructive sleep apnea draw soft tissue of the front of the neck of the subject, in particular at or near the oropharynx, into a cavity by applying negative pressure. The opening of the cavity is formed by a rim of a body that is configured to be engaged, externally, with a medial portion of the anterior side of the neck such that engagement between the rim and the neck forms a chamber that can be sealed from atmospheric pressure. Movement of the soft tissue may thus reduce temporary airway obstruction.

### CROSS-REFERENCE TO RELATED APPLICATIONS

This patent application claims the priority benefit under 35 U.S.C. §119(e) of U.S. Provisional Application No. 61/655,542 filed on Jun. 5, 2012, the contents of which are herein incorporated by reference.

### BACKGROUND OF THE INVENTION

1. Field of the Invention

The present disclosure pertains to systems and methods for treating obstructive sleep apnea, and, in particular, to applying negative pressure to a subject's neck to move soft tissue in or near the oropharynx in order to reduce temporary airway obstruction.

2. Description of the Related Art

It is known that sleep apnea is a common sleep disorder. It is well known that obstructive sleep apnea may result when soft tissue in or near the oropharynx, in particular the tongue, temporarily, and at least partially, obstruct the airway of a patient. It is known that, in some cases, the sleeping position of a patient may affect at least some of said soft tissue, by virtue of the direction of gravitational forces. It is known that the airway mechanics of a subject may be measured and/or determined through sensory readings and/or associated signal processing.

### SUMMARY OF THE INVENTION

Accordingly, it is an object of one or more embodiments of the present disclosure to provide a system for treatment of obstructive sleep apnea of a subject. The subject has a neck that includes an anterior side, which may be referred to as the forward-facing side, assuming at least the head of the subject is positioned upright. The system includes a body having a rim that forms an opening of a cavity formed by the body, and a pneumatic connector. The rim is configured to be engaged, externally, with a medial portion of the anterior side of the neck of the subject. The body is being shaped such that engagement between the rim and the neck of the subject forms a chamber between an interior of the cavity and the neck. The arc length of the area of engagement along a circumference of the neck ranges between about 60 degrees and about 120 degrees. The pneumatic connector is configured to fluidly communicate the chamber with a source of negative pressure. Responsive to negative pressure being applied to the chamber through the pneumatic connector, soft tissue of the subject is drawn into the cavity through the opening formed by the rim to reduce temporary airway obstruction.

It is yet another aspect of one or more embodiments of the present disclosure to provide a method for treatment of obstructive sleep apnea of a subject, the method being implemented by a system that includes a body having a rim that forms an opening of a cavity formed by the body, and a pneumatic connector that fluidly communicates the cavity with a source of negative pressure. The method includes; engaging, by the rim of the body, a medial portion of the anterior side of the neck of the subject such that a chamber is formed between an interior of the cavity and the neck, wherein an arc length of the area of engagement along a circumference of the neck ranges between about 60 degrees and about 120 degrees; and applying a negative pressure created by the source of negative pressure to the chamber through the pneumatic connector such that soft tissue of the subject is drawn into the cavity through the formed opening to reduce temporary airway obstruction.

It is yet another aspect of one or more embodiments to provide a system configured for treatment of obstructive sleep apnea of a subject. The system includes means for forming an opening of a cavity, means for engaging a medial portion of the anterior side of the neck of the subject such that a chamber is formed between an interior of the cavity and the neck, means for fluidly communicating the chamber with a source of negative pressure, and means for applying a negative pressure to the chamber such that soft tissue of the subject is drawn into the cavity through the formed opening to reduce temporary airway obstruction. The arc length of the area of engagement along a circumference of the neck ranges between about 60 degrees and about 120 degrees.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1 schematically illustrates a system for treatment of obstructive sleep apnea, in accordance with one or more embodiments;

FIG. 2 illustrates a method for treatment of obstructive sleep apnea, in accordance with one or more embodiments; and

FIG. 3A-3B illustrate a front and side view of the subject and an area of engagement with the anterior side of the neck of the subject.

### DETAILED DESCRIPTION OF EXEMPLARY EMBODIMENTS

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

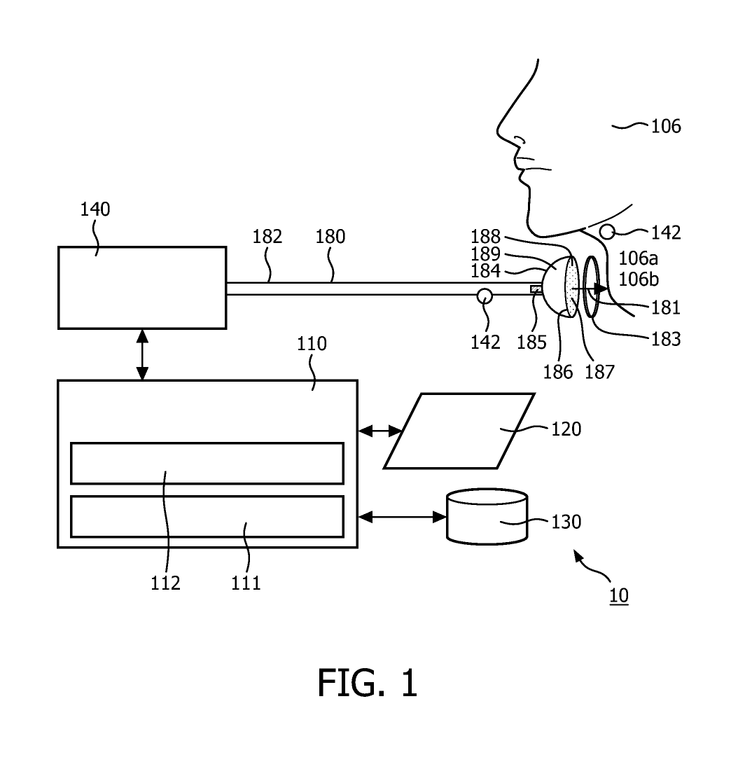

FIG. 1 schematically illustrates a system 10 for treatment of obstructive sleep apnea of a subject 106. The neck of subject 106 includes an anterior side. The anterior side of the neck includes a medial portion 106a, which includes soft tissue 106b, in particular at or near the oropharynx of subject 106. For example, the soft tissue may include the tongue of subject 106.

System 10 includes a body 184 which is shaped such that engagement between body 184, and/or components included with body 184, and the neck of subject 106 forms a chamber 189. System 10 further includes a pneumatic connector 185 configured to fluidly communicate chamber 189 with a source of (continuous) negative pressure 140 such that, responsive to a negative pressure being applied to chamber 189 through pneumatic connector 185, soft tissue 106b of subject 106 is drawn into a cavity 188 which is formed by body 184. Body 184 includes a rim 186 that forms an opening of cavity 188. Rim 186 is configured to be engaged with medial portion 106a of the anterior side of the neck of subject 106. Rim 186 may be formed integrally by body 184, by a seal 183 coupled to body 184 that is configured to sealingly engage the anterior side of the neck of subject 106, and/or by other suitable structures that are sufficiently rigid in order to withstand the application of negative pressure without collapsing. In some embodiments, seal 183 may be integrated within and/or combined with body 184 such that seal 183 forms a rim that engages with medial portion 106a as described, for example at or near rim 186.

Rim 186 and/or seal 183 can have any of a number of variety of configurations, such as multiple flaps, and can be formed from a variety of materials or combinations of materials, such as gels, silicones, foams, rubber. In addition, the softness or durometer of the seal can be any conventional durometer, or variable durometer, e.g., softer at the portion of the seal that contacts the surface of the user.

System 10 may further include one or more of source of negative pressure 140, one or more sensors 142, a processor 110, a control module 111, a parameter determination module 112, and/or other components.

As depicted in FIG. 1, body 184 forms cavity 188. The depiction of body 184 in the shape of a cup (or elliptic paraboloid) is exemplary, and not intended to be limiting in any way. For example, in some embodiments, body 184 may be integrated in and/or combined with a neck brace, neck collar, cervical collar, neck wrap, neck support system, straps, and/or other suitable structure to provide and/or maintain mechanical stability and/or relative position of the neck and/or body 184. Some or all of body 184 may be sufficiently rigid, at least during use of system 10, to withstand the application of negative pressure through pneumatic connector 185 without collapsing, such that chamber 189 and/or the interior of cavity 188 may have a persistent pressure below atmospheric pressure.

For the purposes of this disclosure, the applied pressure differential during use of system 10 may range from −5 cmH₂0 to −100 cmH₂0. Body 184 may engage the neck of subject 106, in particular medial portion 106a of the anterior side of the neck of subject 106, by moving body 184 towards the neck of subject 106, as indicated by directional arrow 181, until rim 186 and/or seal 183 touch the skin of subject 106. Chamber 189 may thus be established when opening 187 of cavity 188 is sealed by subject 106.

It is understood that the sealing engagement through rim 186 and/or seal 183 may not be perfect and may leak a small leak flow during use. The leak flow may range from about 10 liters per minute to about 50 liters per minute, depending on various factors including how closely the shape of rim 186 and/or seal 183 conform to subject 106, the pressure differential between the interior of cavity 188 and atmospheric pressure, skin conditions of subject 106 at or near the area of engagement with body 184, atmospheric and/or environmental conditions, materials used in system 10, the size/volume of cavity 188 and/or chamber 189, the planar shape of rim 186 and/or seal 183, movement by subject 106, and/or various other factors.

The volume of cavity 188 and/or chamber 189 may be adjusted for subjects of different sizes, for example adults, children, neonates, and/or other categorizations of subjects based on size. In some embodiments, the volume of cavity 188 and/or chamber 189 may be about 150 cc, about 250 cc, about 400 cc, about 500 cc, about 600 cc, about 700 cc, about 800 cc, ranging between about 150 cc and about 300 cc, ranging between about 200 cc and about 500 cc, ranging between about 300 and about 600 cc, ranging between about 400 cc and about 800 cc, and/or other volumes.

The area of engagement between rim 186 and/or seal 183 and medial portion 106a of the anterior side of the neck of subject 106 spans a predetermined lateral width and a predetermined height in a direction transverse to the lateral width. For the purposes of this disclosure, the area of engagement refers to the area within which negative pressure is applied to a medial portion of the anterior side of the neck of subject 106. System 10, body 184, and/or any components of system 10 may extend beyond the area of engagement in any direction, for example to provide and/or maintain mechanical stability in relation to subject 106.

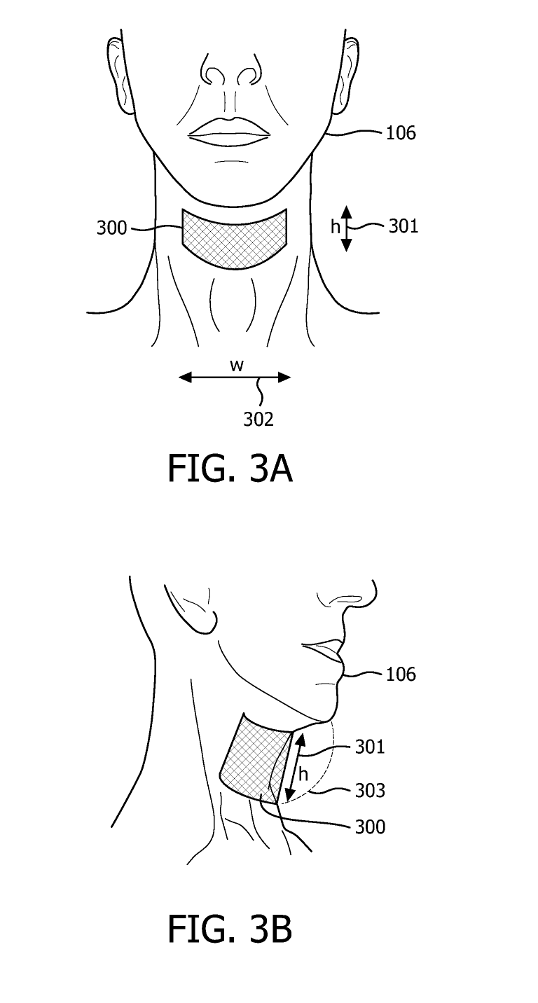

By way of illustration, FIG. 3A illustrates a front view and FIG. 3B illustrates a side view of subject 106. An area of engagement 300 (as e.g. depicted in FIG. 3A) spans lateral width 302 (labeled “w”) and height 301 (labeled “h”) in a direction transverse to the lateral width. In some embodiments, the predetermined lateral width is less than about 2 inches, less than about 2.5 inches, less than about 3 inches, less than about 3.5 inches, less than about 4 inches, less than about 4.5 inches, less than about 5 inches, less than about 6 inches, and/or another predetermined width. In some embodiments, the predetermined height is less than about 2 inches, less than about 2.5 inches, less than about 3 inches, less than about 3.5 inches, less than about 4 inches, less than about 4.5 inches, less than about 5 inches, and/or another predetermined height. The shape of the area of engagement may be circular, oval, rectangular, and/or another (convex) polygonal shape. Area of engagement 300 spans an arc portion of the circumference of the neck of subject 106.

In some embodiments, the arc length of area of engagement 300 of the circumference of the neck of subject 106 may be less than about 140 degrees, less than about 120 degrees, less than about 90 degrees, about 60 degrees, ranging between about 90 and about 120 degrees, ranging between about 60 and about 90 degrees, ranging between about 60 and about 120 degrees, ranging between about 90 and about 150 degrees, and/or another arc length that is smaller than 180 degrees. In some embodiments, the body used to form the chamber (as described elsewhere herein) may be anchored, connected, stabilized, and/or otherwise engaging with the chin of subject 106, as indicated in FIG. 3B through outline 303. Note that the shape, size, and/or volume of the body or chamber are not intended to be limited by the depiction of outline 303 in FIG. 3B.

Referring to FIG. 1, pneumatic connector 185 may be formed within body 184, integrated with body 184, and/or otherwise combined with body 184. The depiction in FIG. 1 of pneumatic connector 185 being positioned on the opposite side of body 184 from opening 187 of cavity 188 is exemplary, and not intended to be limiting in any way. Through pneumatic connector 185, chamber 189 communicates fluidly with a source of negative pressure 140 such that, responsive to a negative pressure being applied to chamber 189, soft tissue 106b of subject 106 is drawn into chamber 189. In some embodiments, system 10 includes source of negative pressure 140. Source of negative pressure 140 may be configured to provide a (pressurized) flow of gas/air from chamber 189. Due to leak flow in the sealing engagement with rim 186 and/or seal 183, air within chamber 189 may be replenished continuously, e.g. from the atmosphere, thereby reducing the pressure differential with atmospheric pressure during use. Source of negative pressure 140 may be a source of continuous negative pressure to continuously counteract a reduction of the pressure differential and/or to maintain a target pressure differential during use.

The flow of gas/air from chamber 189 in FIG. 1 may be drawn by source of negative pressure 140 via a circuit 180. Circuit 180 may include a conduit 182 and/or other constituent components. Conduit 182 may include a flexible length of hose, or other conduit, that places body 184, via pneumatic connector 185, in fluid communication with source of negative pressure 140. Conduit 182 forms a flow path through which the flow of gas/air is communicated. Source of negative pressure 140 may be powered through one or more of a standard AC power plug, one or more batteries, and/or one or more other power supplies, power sources, and/or power connectors. The amount of power required during use of system 10 may vary according to various factors, including patient-specific considerations, the applicable range of leak flow, the quality of the sealing engagement between rim 186 and/or seal 183 and the skin of subject 106, and/or various other factors.

In some embodiments, source of negative pressure 140 of system 10 in FIG. 1 may be configured such that a therapeutic amount of pressure differential between the interior of cavity 188 and atmospheric pressure may be established, responsive to appropriate engagement between rim 186 and/or seal 183 and subject 106, within a predetermined amount of time. The predetermined amount of time may be about 5 seconds, about 10 seconds, about 15 seconds, about 20 seconds, and/or another predetermined amount of time. Corresponding flow capacities for source of negative pressure 140 may vary according to various factors, including the size/volume of cavity 188 and/or chamber 189, patient-specific considerations, the applicable range of leak flow, the quality of the sealing engagement between rim 186 and/or seal 183 and the skin of subject 106, and/or various other factors. In some embodiments, the flow capacity of source of negative pressure 140 may be about 5 liters per minute, about 10 liters per minute, about 50 liters per minute, about 100 liters per minute, between about 5 liters per minute and 50 liters per minute, between about 10 liters per minute and 100 liters per minute, and/or another amount of flow capacity.

In some embodiments, body 184 may be shaped such that engagement with the neck of subject 106 forms multiple chambers, allowing a more fine-grained level of control of the amount of negative pressure that is applied on subsections of the area of engagement. For example, different chambers may be used to establish and/or maintain different pressure differentials with atmospheric pressure, for example through the use of multiple seals.

Electronic storage 130 of system 10 in FIG. 1 comprises electronic storage media that electronically stores information. The electronic storage media of electronic storage 130 may include one or both of system storage that is provided integrally (i.e., substantially non-removable) with system 10 and/or removable storage that is removably connectable to system 10 via, for example, a port (e.g., a USB port, a FireWire port, etc.), a slot (e.g., an SD card slot, etc.), or a drive (e.g., a disk drive, etc.). Electronic storage 130 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. Electronic storage 130 may store software algorithms, information determined by processor 110, information received via user interface 120, and/or other information that enables system 10 to function properly. For example, electronic storage 130 may record or store information pertaining to occurrences of obstructive sleep apnea (as discussed elsewhere herein), and/or other information. Electronic storage 130 may be a separate component within system 10, or electronic storage 130 may be provided integrally with one or more other components of system 10 (e.g., processor 110).

User interface 120 of system 10 in FIG. 1 is configured to provide an interface between system 10 and a user (e.g., user 108, subject 106, a caregiver, a therapy decision-maker, etc.) through which the user can provide information to and receive information from system 10. This enables data, results, and/or instructions and any other communicable items, collectively referred to as “information,” to be communicated between the user and system 10. An example of information that may be conveyed to user 108 is an indication of the current level of negative pressure being applied to chamber 189 during use of system 10. Examples of interface devices suitable for inclusion in user interface 120 include a keypad, buttons, switches, a keyboard, knobs, levers, a display screen, an electronic display configured to display information, a touch screen, speakers, a microphone, an indicator light, an audible alarm, and a printer. Information may be provided to user 108 or subject 106 by user interface 120 in the form of auditory signals, visual signals, tactile signals, and/or other sensory signals.

It is to be understood that other communication techniques, either hard-wired or wireless, are also contemplated herein as user interface 120. For example, in one embodiment, user interface 120 may be integrated with a removable storage interface provided by electronic storage 130. In this example, information is loaded into system 10 from removable storage (e.g., a smart card, a flash drive, a removable disk, etc.) that enables the user(s) to customize system 10. Other exemplary input devices and techniques adapted for use with system 10 as user interface 120 include, but are not limited to, an RS-232 port, RF link, an IR link, modem (telephone, cable, Ethernet, internet or other). In short, any technique for communicating information with system 10 is contemplated as user interface 120.

One or more sensors 142 of system 10 in FIG. 1 are configured to generate output signals conveying information related to one or more of a gas parameter, a respiratory or airway mechanics parameter, a position and/or orientation of subject 106 or any particular body part of subject 106, and/or other parameters. Gas parameters may include one or more of flow rate, (airway) pressure, humidity, temperature, gas composition, velocity, acceleration, and/or other gas parameters. Gas parameters may pertain to the flow of gas at or near the airway of subject 106, for example within circuit 180. One or more sensors 142 may be in fluid communication with conduit 182 and/or body 184. Respiratory or airway mechanics parameters may include one or more of respiratory rate, breathing period, inhalation time or period, exhalation time or period, peak flow, respiration flow curve shape, transition time from inhalation to exhalation and/or vice versa, transition time from peak inhalation flow rate to peak exhalation flow rate and/or vice versa, maximum proximal pressure drop (per breathing cycle and/or phase), inhaled tidal volume (per inhalation), exhaled tidal volume (per exhalation), lung compliance, airway resistance, and/or other respiratory or airway mechanics parameters. Position and/or orientation information may be used to determine whether subject 106 is in a prone position, supine position, on a side, and/or another position, which may in turn be used as a basis for, e.g., controlling source of negative pressure 140.

In some embodiments, the conveyed information may pertain to a leak in the sealing engagement between rim 186 and/or seal 183 and the skin of subject 106. In some embodiments, the conveyed information may pertain to the current sleep stage of subject 106. Parameters may be determined on a breath-by-breath basis, on a cough-by-cough basis, per individual respiratory phase, and/or at other intervals.

The illustration of sensor 142 including two members in FIG. 1 is not intended to be limiting. The illustration of a sensor 142 at or near body 184 is not intended to be limiting. The illustration of a sensor 142 at or near the neck of subject 106 is not intended to be limiting. In one embodiment sensor 142 includes a plurality of sensors operating as described above by generating output signals conveying various types of information. For example, conveyed information may be related to a mechanical unit of measurement of a component of source of negative pressure 140 (or of a device integrated, combined, or coupled therewith) such as valve drive current, rotor speed, motor speed, blower speed, fan speed, or a related measurement that may serve as a proxy for any of the previously listed parameters through a previously known and/or calibrated mathematical relationship. Resulting signals or information from one or more sensors 142 may be transmitted to processor 110, user interface 120, electronic storage 130, and/or other components of system 10. This transmission may be wired and/or wireless.

Processor 110 of system 10 in FIG. 1 is configured to provide information processing capabilities in system 10. As such, processor 110 includes one or more of a digital processor, an analog processor, a digital circuit designed to process information, an analog circuit designed to process information, a state machine, and/or other mechanisms for electronically processing information. Although processor 110 is depicted in FIG. 1 as a single entity, this is for illustrative purposes only. In some embodiments, processor 110 includes a plurality of processing units.

As is shown in FIG. 1, processor 110 is configured to execute one or more computer program modules. The one or more computer program modules include one or more of control module 111, parameter determination module 112, and/or other modules. Processor 110 may be configured to execute modules 111-112 by software; hardware; firmware; some combination of software, hardware, and/or firmware; and/or other mechanisms for configuring processing capabilities on processor 110.

It should be appreciated that although modules 111-112 are illustrated in FIG. 1 as being co-located within a single processing unit, in embodiments in which processor 110 includes multiple processing units, one or more of modules 111-112 may be located remotely from the other modules. The description of the functionality provided by the different modules 111-112 described herein is for illustrative purposes, and is not intended to be limiting, as any of modules 111-112 may provide more or less functionality than is described. For example, one or more of modules 111-112 may be eliminated, and some or all of its functionality may be incorporated, shared, integrated into, and/or otherwise provided by other ones of modules 111-112. Note that processor 110 may be configured to execute one or more additional modules that may perform some or all of the functionality attributed below to one of modules 111-112.

Control module 111 of system 10 in FIG. 1 is configured to control source of negative pressure 140. Control module 111 may be configured to control the level of negative pressure applied during use of system 10 in accordance with one or more of a (respiratory) therapy regimen, one or more algorithms that control pressure adjustments and/or changes in the pressure differential between the interior of cavity 188 and atmospheric pressure, and/or other factors. Control module 111 may be configured such that the level of negative pressure is varied over time in accordance with a respiratory therapy regimen and/or treatment. For example, the level of negative pressure may be adjusted based on a target pressure differential between the interior of cavity 188 and atmospheric pressure. Signals and/or information received through user interface 120 may be used by control module 111, e.g. in a feedback manner, to adjust one or more therapy modes/settings/operations of system 10.

In some embodiments, user 108 and/or subject 106 may (e.g. manually) control one or more pressure levels used during operation of system 10, e.g. through user interface 120. Control module 111 may be configured to time its operations and/or adjustments relative to transitional moments in the sleep stages of a subject, and/or in any other relation to any detected events (including but not limited to obstructive sleep apneas) during therapeutic use of system 10. For example, responsive to detection of an occurrence of obstructive sleep apnea, the pressure differential may be increased to reduce to temporary airway obstruction.

In some embodiments, operation of control module 111 may be governed through programmatic control, e.g. by an algorithm implemented through instructions that are executed by control module 111. Such an algorithm may be designed to titrate operating conditions of system 10 such that a target operating condition is reached and/or accomplished over time. For example, the algorithm may use a target pressure differential that corresponds to and/or changes with a determined sleep stage of subject 106. In some embodiments, the pressure differential may be gradually decreased as long as no occurrences of obstructive sleep apnea are detected and/or the airway of subject 106 remains open or unobstructed.

Parameter determination module 112 of system 10 in FIG. 1 is configured to determine one or more gas parameters, respiratory parameters, airway mechanics, current sleep stage of subject 106, and/or other parameters from output signals generated by sensor(s) 142. In some embodiments, parameter determination module 112 may be configured to determine and/or estimate the leak flow. Parameters determined by parameter determination module 112 and/or received through one or more sensors 142 may be used by control module 111, e.g. in a feedback manner, to adjust therapy modes/settings/operations of system 10. For example, parameter determination module 112 may be configured to determine airway resistance of subject 106. Responsive to an increase in measured airway resistance, the target pressure differential may be adjusted.

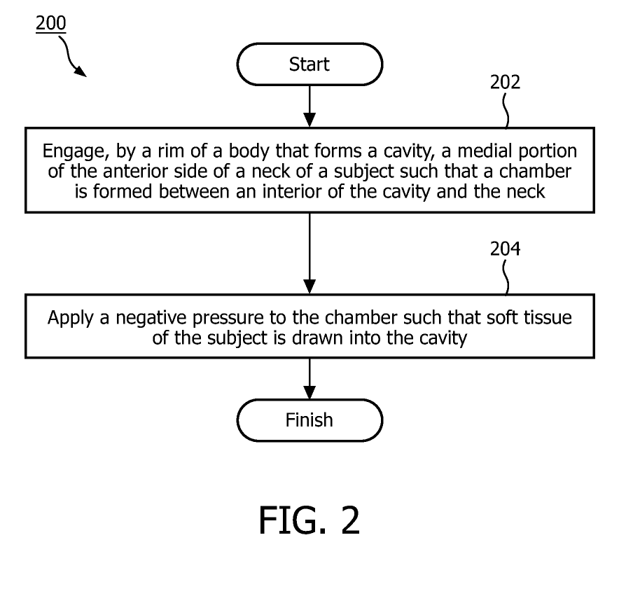

FIG. 2 illustrates a method 200 of treating a subject for obstructive sleep apnea and/or other kinds of temporary airway obstruction. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At an operation 202, a rim of a body that forms a cavity engages a medial portion of the anterior side of the neck of a subject such that a chamber is formed between the interior of the cavity and the neck. The arc length of the area of engagement along a circumference of the neck ranges between about 60 degrees and about 120 degrees. In some embodiments, operation 202 is performed by a body and/or rim the same as or similar to body 184 and/or rim 186 (shown in FIG. 1 and described herein).

At an operation 204, a negative pressure is applied to the chamber such that soft tissue of the subject is drawn into the cavity to reduce temporary airway obstruction. In some embodiments, operation 204 is performed by a source of negative pressure the same as or similar to source of negative pressure 140 (shown in FIG. 1 and described herein).

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the disclosure described in detail for the purpose of illustration based on what is currently considered to be the most practical and preferred embodiments, it is to be understood that such detail may be solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A system for treatment of obstructive sleep apnea of a subject, the subject having a neck that includes an anterior side, the system comprising:
a body having a rim that forms an opening of a cavity formed by the body, the rim being configured to be engaged with a medial portion of the anterior side of the neck of the subject in an area of engagement, the body being shaped such that engagement between the rim and the neck of the subject forms a chamber between an interior of the cavity and the neck, wherein an arc length of the area of engagement along a circumference of the neck ranges between about 60 degrees and about 120 degrees; and
a pneumatic connector configured to fluidly communicate the chamber with a source of negative pressure such that, responsive to a negative pressure being applied to the chamber through the pneumatic connector, soft tissue of the subject is drawn into the cavity through the opening formed by the rim to reduce temporary airway obstruction.
one or more sensors configured to generate output signals conveying information related to one or both of a position and/or an orientation of the neck of the subject; and wherein the one or more sensors are further configured to generate output signals conveying information related to airway mechanics of the subjects, and wherein control of the source of negative pressure is further based on the information related to the airway mechanics; and
one or more processors configured to control the source of negative pressure based on the position and/or the orientation of the neck of the subject conveyed by the output signals.

2. The system of claim 1, wherein the body further comprises a seal, wherein the rim is formed by the seal, and wherein the seal is further configured to sealingly engage the anterior side of the neck of the subject.

3. The system of claim 1, further comprising the source of negative pressure, wherein the source of negative pressure has a flow capacity of at least about 10 liters per minute.

4-5. (canceled)

6. A method for treatment of obstructive sleep apnea of a subject, the subject having a neck that includes an anterior side, the method being implemented by a system that includes a body having a rim that forms an opening of a cavity formed by the body, and a pneumatic connector that fluidly communicates the cavity with a source of negative pressure, the method comprising:
engaging, by the rim of the body, a medial portion of the anterior side of the neck of the subject such that a chamber is formed between an interior of the cavity and the neck, wherein an arc length of the area of engagement along a circumference of the neck ranges between about 60 degrees and about 120 degrees; and
applying a negative pressure created by the source of negative pressure to the chamber through the pneumatic connector such that soft tissue of the subject is drawn into the cavity through the formed opening to reduce temporary airway obstruction.
generating output signals conveying information related to one or both of a position and/or an orientation of the neck of the subject; and wherein the conveyed information is further related to airway mechanics of the subject, and wherein controlling the negative pressure is further based on the information related to the airway mechanics; and
controlling the negative pressure based on the position and/or the orientation of the neck of the subject conveyed by the output signals.

7. The method of claim 6, wherein the engaging step is performed such that the formed opening engages the anterior side of the neck in a sealing engagement.

8. The method of claim 6, wherein applying the negative pressure to the chamber is performed using a flow capacity of at least about 10 liters per minute.

9-10. (canceled)

11. A system configured to provide treatment of obstructive sleep apnea of a subject, the subject having a neck that includes an anterior side, the system comprising:
means for forming an opening of a cavity;
means for engaging a medial portion of the anterior side of the neck of the subject such that a chamber is formed between an interior of the cavity and the neck, wherein an arc length of the area of engagement along a circumference of the neck ranges between about 60 degrees and about 120 degrees;
means for fluidly communicating the chamber with a source of negative pressure; and
pressure means for applying a negative pressure to the chamber such that soft tissue of the subject is drawn into the cavity through the formed opening to reduce temporary airway obstruction
means for generating output signals conveying information related to one or both of a position and/or an orientation of the neck of the subject; and wherein the conveyed information is further related to airway mechanics of the subject, and wherein the means for controlling the negative pressure is further based on the information related to the airway mechanics; and
means for controlling the negative pressure based on the position and/or orientation of the neck of the subject conveyed by the output signals.

12. The system of claim 11, wherein the means for engaging operates such that the formed opening engages the anterior side of the neck in a sealing engagement.

13. The system of claim 11, wherein the pressure means has a flow capacity of at least about 10 liters per minute.

14-15. (canceled)
